(19) United States
(12) Patent Application Publication
(10) Pub. No.: US 2019/0377444 A1
(43) Pub. Date: Dec. 12, 2019

(54) METAL MESH TOUCH MODULE

(71) Applicants: Interface Technology (ChengDu) Co., Ltd., ChengDu (CN); Interface Optoelectronics (ShenZhen) Co., Ltd., ShengZhen (CN); General Interface Solution Limited, Miaoli County (TW)

(72) Inventors: Chia-Chi YEH, Miaoli County (TW); Yue-Feng Yang, Miaoli County (TW); Po-Lin Chen, Miaoli County (TW); Ya-Yin Cheng, Miaoli County (TW); Yen-Heng Huang, Miaoli County (TW)

(21) Appl. No.: 16/038,715

(22) Filed: Jul. 18, 2018

(30) Foreign Application Priority Data
Jun. 6, 2018 (CN) 201810574348.X

(51) Int. Cl. G06F 3/041

(52) U.S. Cl. CPC G06F 3/0412; G06F 2203/04112

(57) ABSTRACT

A metal mesh touch module that alters the position of at least one auxiliary line disposed at the periphery of mesh units and conceals the auxiliary line by an ink layer that hides the auxiliary line. The display module is partitioned by a first partition line into a function zone and a border zone, the border zone having an ink layer. A touch electrode is disposed on the display module and comprises a plurality of mesh units. A protective covering is disposed on the touch electrode and partitioned by a second partition line into a visible zone and a bezel ink zone, the bezel ink zone comprising a light-blocking material. At least one auxiliary line is disposed on the periphery of the mesh units, electrically connected to the mesh units, and disposed on the touch electrode between the first partition line and the second partition line.

### CROSS-REFERENCE TO RELATED PATENT APPLICATION

This non-provisional application claims priority to and the benefit of, pursuant to 35 U.S.C. § 119(a), patent application Serial No. CN201810574348.X filed in China on Jun. 6, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to the field of touch sensitive devices and, more particularly, to technology for increasing the wiring area of a metal mesh touch module.

### BACKGROUND

Compared with single-touch panels, multi-touch panels can be operated with multiple fingers simultaneously thus making the operation more intuitive. Single-layer multi-touch panels not only include the advantages of the general multi-touch panel but are also thinner which is advantageous to the development of thin and lightweight devices.

In conventional devices the conductive layer of touch panels are mainly formed on an insulating substrate by processes of vacuum sputtering and patterned etching with indium tin oxide compounds. These processes not only waste a large amount of indium tin oxide compound material during etching but also generate a relatively large amount of industrial waste liquid containing heavy metals. Additionally, metal indium in the indium tin oxide compound is a rare resource, resulting in a higher than needed cost of the touch panels.

In order to reduce the costs and to meet the demand for thinner and lightweight products, in recent years, the metal mesh touch panels (Metal Mesh TP) have been developed in which a conductive layer of a sensing layer is replaced with an indium tin oxide compound to act as a touch electrode. The touch electrode is a double-layer structure where one layer is a driving electrode, and the other layer is a sensing electrode. Thereby a mutual capacitance is formed between the driving and sensing layers.

The metal mesh has a requirement for the number of intersections for each channel. When the width of the channel is not sufficient, the sensitivity may decrease. Therefore, it is necessary to increase the number of auxiliary lines to meet the requirements for the number of intersections of the channel. However, the auxiliary line of the narrow-frame touch device may easily exceed the display area and result in a negative user experience.

### SUMMARY

In order to overcome the disadvantages of the conventional devices and technologies the present invention provides a metal mesh touch module which significantly prevents the chance that auxiliary lines will be seen by users while at the same time providing sufficient junctions to ensure the required reliability.

The present invention provides a metal mesh touch module, comprising a display module, a touch electrode and a protective covering. The display module is segmented by a first partition line into a function zone and a bezel ink zone. The touch electrode is disposed on the display module and comprises a plurality of mesh units.

Adjacent mesh units are electrically connected to each other. The mesh units each comprise a plurality of mesh sides and junctions formed due to connections of adjacent mesh sides. The protective covering is disposed on the touch electrode and segmented by a second partition line into a visible zone and a bezel ink zone. Typically, the visible zone is larger than the function zone. The bezel ink zone comprises an opaque, semi-opaque, or translucent material.

In an embodiment of the present invention at least one auxiliary line is disposed peripherally to one or more mesh units, electrically connected to one or more of the mesh units, and disposed on the touch electrode between the first partition line and the second partition line.

In an embodiment of present invention, the auxiliary line comprises a main line and a plurality of branch lines. The main line extends in a direction and is electrically connected to peripheral mesh units. The branch lines are electrically connected to the main line and/or one of the mesh sides.

In an embodiment of present invention, the auxiliary line is a straight line, a curved line, a wavy line, an irregular line, or a line derived from an equation involving device size, display size, heat dissipation requirements, or processor speed.

In an embodiment of present invention, the auxiliary line has a greater line width than the mesh sides.

In an embodiment of present invention, the ink layer is disposed at the periphery of the function zone.

In an embodiment of present invention, the display module comprises a backlight module.

### BRIEF DESCRIPTION OF THE DRAWINGS

FIG. 1 is a drawing illustrating the structure of a metal mesh touch module according to an embodiment of the present invention; and

FIG. 2 is a drawing illustrating the position of an auxiliary line of the metal mesh touch module according to an embodiment of the present invention.

### DETAILED DESCRIPTION

Features and functions of technical structures and measures taken to achieve the aforesaid objectives and advantages of the present invention are illustrated with preferred embodiments, depicted by drawings, and described in detail below, but the present disclosure is not limited thereto.

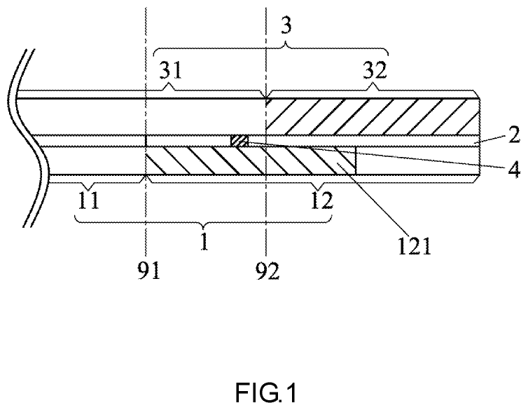

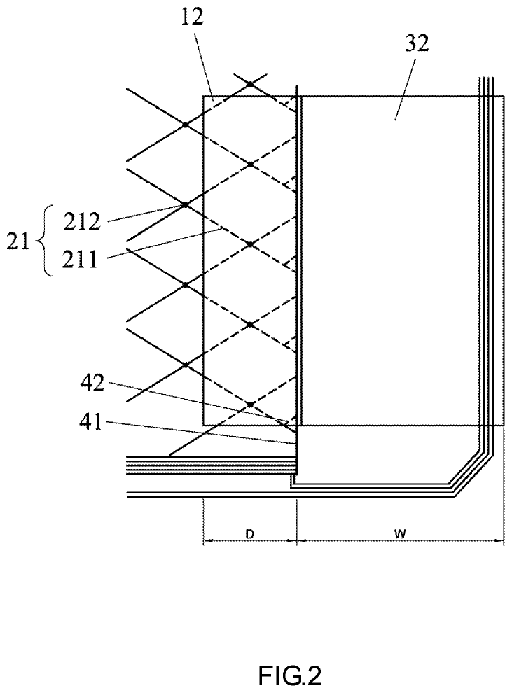

Referring to FIGS. 1-2, the metal mesh touch module of the present invention comprises a display module 1, a touch electrode 2 and a protective covering 3.

The display module comprises a backlight module. The backlight module provides a light source. The display module 1 is segmented by a first partition line 91 into a function zone 11 and a border zone 12. The light emitted by the backlight module illuminates the function zone 11 or a portion of the function zone 11. The border zone 12 surrounds the function zone 11 and has an ink layer 121 for concealing circuitry of the display module 1. In an embodiment, the ink layer 121 is disposed at the periphery of the function zone 11.

The touch electrode 2 is disposed on the display module 1 and is a metal mesh electrode structure comprising a plurality of mesh units 21. Adjacent mesh units 21 are electrically connected to each other. The mesh units 21 each comprise a plurality of mesh sides 211 and junctions 212 formed by connection of any two adjacent mesh sides 211, allowing each mesh unit 21 to take on any shape, such as rhombus, triangle, quadrilateral or hexagon.

The protective covering 3 is disposed on the touch electrode 2 and comprises a transparent material or glass to protect the metal mesh touch module in its entirety. The protective covering 3 is segmented by a second partition line 92 into a visible zone 31 and a border or bezel ink zone 32.

The visible zone 31 is larger than the function zone 11. The bezel ink zone 32 comprises a light-blocking material to block incoming and outgoing light rays. However, in other embodiments of the present invention the bezel ink zone comprises a semi-opaque or translucent material to partially block or filter undesirable incoming or outgoing light rays.

At least one auxiliary line 4 is disposed on the periphery of the mesh units 21. The auxiliary line 4 is electrically connected to peripheral mesh units 21. The auxiliary line 4 is disposed on the touch electrode 2 between the first partition line 91 and the second partition line 92.

To prevent the incorrect junction locations and spatial signals, a feasible solution involves downsizing the outermost channel. However, the solution may not work for some products, as these products each require a channel to have three metal mesh junctions 212 in order to meet requirements for reliability of finished products. In view of this, in an embodiment of the present invention, the auxiliary line 4 is disposed at the outermost channel. The auxiliary line 4 is electrically connected to the mesh units 21. The auxiliary line 4 is separated from the edge of the touch electrode 2 by a distance equal to three times the mesh pitch. The auxiliary line 4 extends in a direction different from the direction in which the channel transmits touch signals.

In an embodiment of present invention, the auxiliary line 4 comprises a main line 41 and a plurality of branch lines 42. The main line 41 extends in a direction and is electrically connected to peripheral mesh units 21. The branch lines 42 are electrically connected to the main line 41 and one of the mesh sides 211. The branch lines 42 are isolated from the edge of the touch electrode 2 by a distance of, for example, 20 to 200 μm.

In an embodiment of present invention, the auxiliary line 4 is a straight line, a curved line, a wavy line or an irregular line.

In an embodiment of present invention, the auxiliary line 4 has a greater line width than the mesh sides 211. In an embodiment, the auxiliary line 4 has a line width of, for example, 10 μm.

Given the aforesaid structure, the auxiliary line 4 looks more conspicuous in the presence of strong backlight emitted from a backlight source and thus must be hidden by the bezel ink zone 32. In an embodiment of the present invention, the auxiliary line 4 is disposed between the first partition line 91 and the second partition line 92 and concealed by the ink layer 121 of the display module 1. The auxiliary line 4 is not only positioned within the visual field of users but also disposed above the ink layer 121; however, the auxiliary line 4 is also of a dark color due to ambient light, and thus the auxiliary line 4 is typically not seen by users, thereby allowing the auxiliary line 4 to be concealed. In an embodiment of the present disclosure, the metal mesh touch module has a wiring-receiving space, and a portion of the ink layer 121 is of a relatively greater length D, thereby increasing a dimension of the wiring-receiving space of narrow-border products by 0.3 to 0.5 mm.

The above detailed description sufficiently explains that the present invention has novelty, non-obviousness and high industrial applicability in terms of objectives and advantages and thus meets patentability requirements. However, the above detailed description is merely about preferred embodiments of the present disclosure but is not restrictive of the implementation and the claims of the present disclosure. Hence, all solutions achieved by equivalent replacements and obvious changes made by persons skilled in the art to the aforesaid embodiments according to the specification and drawings of the present disclosure shall fall within the scope of the present disclosure.

1. A metal mesh touch module, comprising:
a display module comprising a backlight module, the backlight module providing a light source, the display module partitioned by a first partition line into a function zone and a border zone, the border zone having an ink layer;
a touch electrode is a metal mesh electrode structure disposed on the display module and comprising a plurality of mesh units, and each of the plurality of mesh units comprises a plurality of mesh sides and junctions formed due to connections of adjacent mesh sides; and
a protective covering disposed on the touch electrode and partitioned by a second partition line into a visible zone and a bezel ink zone, the bezel ink zone comprising a light-blocking material,
wherein at least one auxiliary line is disposed on the periphery of mesh units, electrically connected to the mesh units, and disposed on the touch electrode between the first partition line and the second partition line, the auxiliary line being a curved line, a wavy line or an irregular line.

2. The metal mesh touch module of claim 1, wherein adjacent mesh units are electrically connected to each other.

3. The metal mesh touch module of claim 2, wherein the auxiliary line comprises a main line and a plurality of branch lines, the main line extending in a direction and being electrically connected to peripheral mesh units, and branch lines being electrically connected to the main line and one of the mesh sides, respectively.

4. (canceled)

5. (canceled)

6. The metal mesh touch module of claim 2, wherein the auxiliary line has a greater line width than the mesh sides.

7. The metal mesh touch module of claim 1, wherein the ink layer is disposed at a periphery of the function zone.

8. (canceled)

9. The metal mesh touch module of claim 1, wherein the visible zone is larger than the function zone.

10. A metal mesh touch module, comprising:
a display module segmented into a function zone and a border zone;
a touch electrode disposed on the display module and comprising a plurality of mesh units; and
a protective covering disposed on the touch electrode and segmented into a visible zone and a bezel ink zone;
wherein at least one auxiliary line is disposed on the periphery of the mesh units, electrically connected to the mesh units, and disposed on the touch electrode, and the at least one auxiliary line is an irregular line.

11. (canceled)

12. The metal mesh touch module of claim 10, wherein the bezel ink zone comprising a light-blocking material.

13. The metal mesh touch module of claim 10, wherein the bezel ink zone comprising an opaque, semi-opaque, or translucent material.
